(19) United States
(12) Patent Application Publication
(10) Pub. No.: US 2005/0067916 A1
(43) Pub. Date: Mar. 31, 2005

(54) Dynamo-electric machine

(76) Inventors: Ryukichi Konaga, Fukuoka (JP); Takao Fujii, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/495,498

(22) PCT Filed: Oct. 18, 2002
(86) PCT No.: PCT/JP02/10863

(30) Foreign Application Priority Data
Nov. 16, 2001 (JP) 2001-351967

(51) Int. Cl. H02K 1/18; H02K 1/28

(52) U.S. Cl. 310/218; 310/259

(57) ABSTRACT

A stator 1 for a rotary electric machine, comprises a ring-like yoke core 2, tooth portion cores 3 with teeth arranged at equal intervals on the inner peripheral side of the yoke core 2, stator coils 5 attached by inserting to each slot part 4 formed between the adjoining tooth portion cores 3 and a connecting part 3A small in sectional area for coupling the inner peripheral sides of the adjoining tooth portion cores 3 so as to electrostatically shield the portion between the stator 1 and the rotor 6, the rotor 6 being set opposite to the inner peripheral sides of the tooth portion cores 3 with a gap held therebetween. Thus, lowering axial voltage and preventing the development of electrolytic corrosion are made possible by cutting off electrostatic capacitance from the slot parts 4 to the rotor 6.

### TECHNICAL FIELD

The present invention relates to a rotary electric machine having an electrostatic shield structure and capable of not only lowering the axial voltage generated owning to high-frequency induction but also preventing the development of electrolytic corrosion.

### BACKGROUND ART

FIGS. 3 and 4 show a rotary electric machine such as an AC motor suitable as an inverter-driven synchronous motor that has heretofore been used for the purpose, for example, of saving energy.

FIG. 3 is a sectional side view of an exemplary synchronous motor using a conventional surface magnet type rotor and FIG. 4 is a plan view of the motor portion of the synchronous motor using the surface magnet type rotor of FIG. 3.

As shown in FIG. 3, the stator 11 of the motor is mounted on the internal circumference of a frame 35 with a load-side bracket 31 and an anti-load-side bracket 32 fixedly fitted in both the respective openings of the frame 35. A rotary shaft 18 is supported rotatably by the load-side bracket 31 and the anti-load-side bracket 32 via rolling bearings 33 and 34 with a rotor 16 mounted in a portion opposite to the stator 11 of the rotary shaft 18. As shown in FIG. 4, the stator 11 comprises a stator core 12, tooth parts 13 arranged at equal intervals on the inner peripheral side of the stator core 12, a stator coil 15 being attached by inserting to each slot part 14 formed between adjoining teeth 13. The rotor 16 is disposed opposite to the inner peripheral sides of the teeth 13 of the stator with a gap held therebetween. Moreover, ring-like permanent magnets 11 are mated with the external circumference of the rotary shaft 18 and mounted on the surface of the rotor (e.g., JP-A-9-93845).

In addition to the surface magnet type rotor above, there has been proposed an internal magnetic type rotor as an inverter-driven synchronous motor in which permanent magnets are embedded in the rotor core. FIG. 5 is a plan view of the motor portion of a synchronous motor using a conventional internal magnet type rotor and as its stator is similar in configuration to the surface magnet type rotor, like reference numerals designate like component parts. What makes the internal magnetic type rotor different from what is shown in FIG. 4 is that a rectangular permanent magnet 27 is mounted on the surface of a rotor 26 (e.g., JP-A-11-206051).

With the development of recent high-speed power semiconductor devices, the carrier frequency of a voltage type PWM inverter is set high in the AC motor such an inverter-driven synchronous motor as described above.

However, with the carrier frequency of the voltage type PWM inverter set higher, there has developed a problem arising from causing the rotary shaft of the motor driven by the inverter to undergo an increase in the generation of voltage (axial voltage) based on high-frequency induction.

More specifically, in explanation of the problem above by reference to FIG. 3, a potential difference existing between the inner and outer rings of the rolling bearings for supporting the rotary shaft 18 grows greater as the axial voltage increases and current (axial current) is apt to flow through the rolling bearings 33 and 34. The axial current causes corrosion called electrolytic corrosion to develop on both tracks of the inner and outer rings and on the rolling surface of the rolling body, which results in deteriorating the durability of the rolling bearings 33 and 34 and this has made it necessary to devise measures to prevent the development of electrolytic corrosion.

In the case of an induction motor, on the other hand, such measures to prevent the development of electrolytic corrosion have heretofore been taken by lowering the axial voltage. More specifically, there is means of widening the gap between the motor stator and the rotor in particular; means of providing a conductor plate or foil such as aluminum foil or a thin non-magnetic metal plate prepared by depositing copper, aluminum or the like on a plastic film, on the side where the motor stator faces the rotor; or an electrostatic shielding means for forming a conductive film on the side where an insulating sleeve contacts the stator, which insulating sleeve is provided between coils wound on the slots of the stator and the openings toward the rotor sides of the slots (e.g., JP-A-2000-197298, JP-A-2000-270507 and U.S. Pat. No. 5,979,087).

Generally, it has been desired to keep the axial voltage directed to the motor from exceeding 1 V in view of preventing the development of electrolytic corrosion so that the operation of the inverter-driven motor is unobstructed when a voltage of 200 to 400 V is applied to the inverter.

Even though the inverter-driven motor is either induction motor or synchronous motor, the electrostatic shielding means above is capable of restraining the axial voltage up to only about 10 V and therefore has failed to prevent the development of electrolytic corrosion. With the means as described above, the problem is that the motor structure becomes complicated and that manufacturing man-hours as well as costs add up.

An object of the invention made to solve the foregoing problems is to provide a rotary electric machine such as an AC motor suitable as an inverter-driven synchronous motor or an induction motor, which rotary electric machine is simple in structure and has an inexpensive electrostatic shield structure, so that it is capable of lowering axial voltage without requiring many manufacturing man-hours.

### DISCLOSURE OF THE INVENTION

In order to solve the foregoing problems, a rotary electric machine according to the invention is characterized by: a fixed portion having a frame, a bracket mounted to one opening of the frame and a bracket mounted to the other opening thereof; a stator mounted to the inner peripheral side of the frame with coils wound on slots; a rotary shaft rotatably supported by the brackets via bearings; and a rotor mounted to the rotary shaft, the stator including a ring-like yoke core, tooth portion cores arranged at equal intervals on the inner peripheral side of the yoke core, stator coils attached by inserting to each slot formed between the adjoining tooth portion cores and a connecting part for coupling the inner peripheral sides of the adjoining tooth portion cores so as to electrostatically shield the portion between the stator and the rotor, the rotor being set opposite to the inner peripheral sides of the tooth portion cores with a gap held therebetween.

### BRIEF DESCRIPTION OF THE DRAWING

FIG. 1 is a plan view of the motor portion of a synchronous motor using a surface magnet type rotor according to an embodiment of the invention.

FIG. 2 is a diagram explanatory of axial voltage generated in the motor, showing impedance of each part of the motor and an equivalent circuit.

FIG. 3 is a sectional side view of an exemplary synchronous motor using a conventional surface magnet type rotor.

FIG. 4 is a plan view of the motor portion of the synchronous motor using the surface magnet type rotor of FIG. 3.

FIG. 5 is a plan view of the motor portion of a synchronous motor using a conventional internal magnetic type rotor.

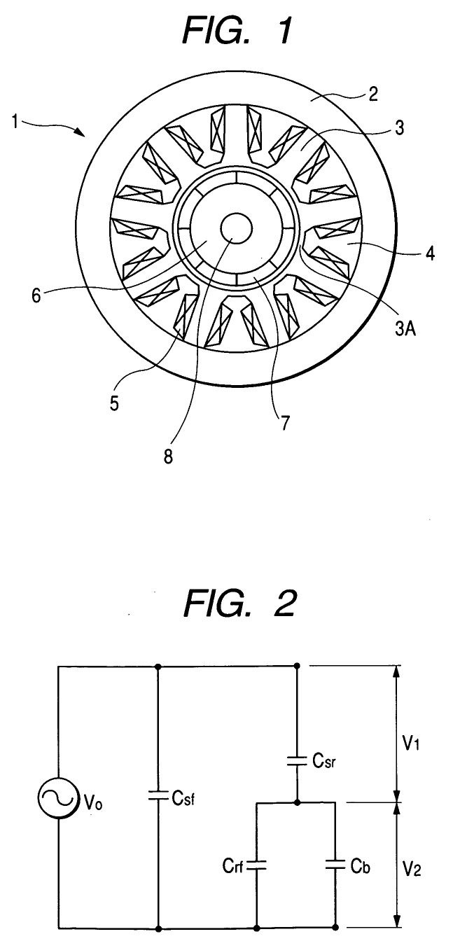

### BEST MODE FOR CARRYING OUT THE INVENTION

An embodiment of the invention will now be described by reference to the drawings.

Fig. i is a plan view of the motor portion of a synchronous motor using a surface magnet type rotor according to an embodiment of the invention.

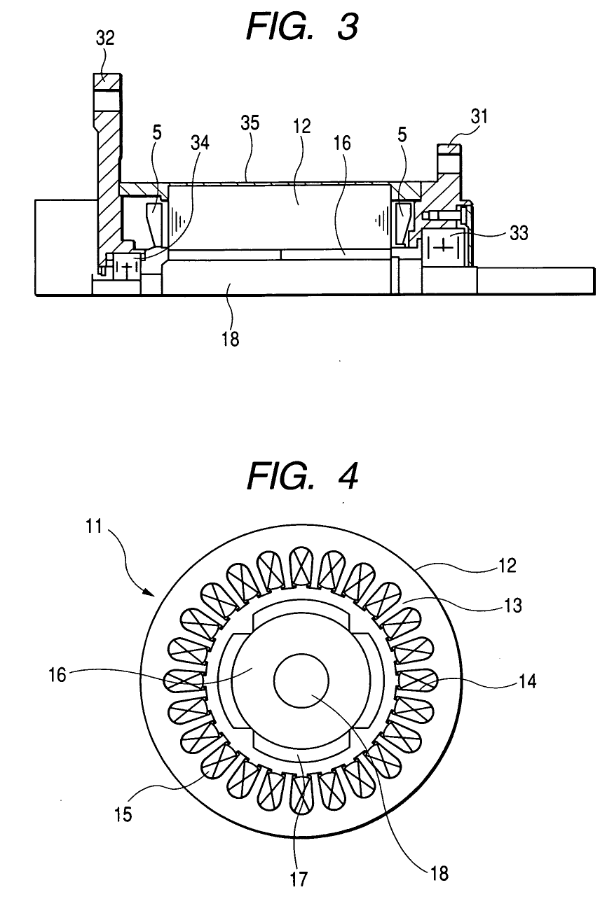

In Fig. i, reference numeral 1 denotes a stator; 2, a yoke core; 3, a tooth portion core; 3A, a connecting part; 4, slot parts; 5, stator coils; 6, a rotor; 7, permanent magnets; and 8, a rotary shaft. Although there is not shown a sectional side view of the motor provided with the motor portion according to the embodiment of the invention, such a sectional side view is similar to FIG. 3 showing the conventional motor and the component elements 31-35 are common among motors, so that the description of them will be omitted.

The invention features the following:

The stator 1 comprises the ring-like yoke core 2, the tooth portion cores 3 with teeth arranged at equal intervals on the inner peripheral side of the yoke core 2, the stator coils 5 attached by inserting to each slot part 4 formed between the adjoining tooth portion cores 3 and the connecting part 3A small in sectional area for coupling the inner peripheral sides of the adjoining tooth portion cores 3 so as to electrostatically shield the portion between the stator 1 and the rotor 6, the rotor 6 being set opposite to the inner peripheral sides of the adjoining tooth portion cores 3 with a gap held therebetween.

Next, the axial voltage according to the embodiment of the invention will be described by using the equivalent circuit.

FIG. 2 is a diagram explanatory of the axial voltage generated in the motor, showing impedance of each part of the motor and the equivalent circuit. Incidentally, the motor is such that as shown in FIG. 3 one of the load-side bracket 31, the anti-load-side bracket 32 and the outer frame (outer box) formed of the frame 35 is assumed to be grounded and connected to the grounding point.

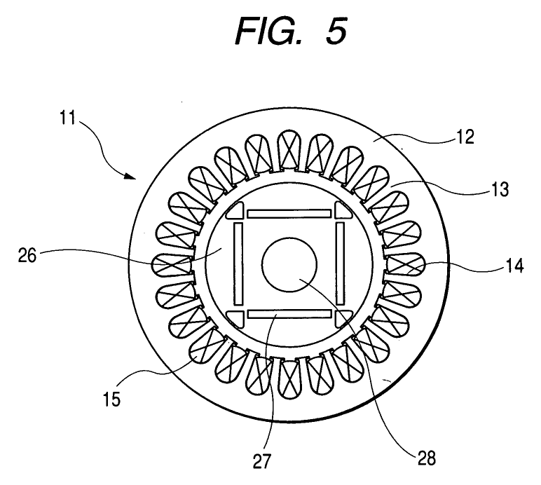

Consequently, the equivalent circuit of the motor concerning an axial voltage V2 is as shown in FIG. 5 and the axial voltage is given by the following equation:
V₂=Cₛᵣ×Vₒ/(C_{rf}+C_{b}+Cₛᵣ)
where Vo=voltage applied between the stator coils 5 and the outer frame, V₁=voltage applied between the stator coils 5 and the rotor 6, V2=axial voltage, Cₛᵣ=electrostatic capacitance between the stator coils 5 and the outer frame, Cₛᵣ=electrostatic capacitance between the stator coil 5 and the rotor 6, C_{b}=electrostatic capacitance between the rolling bearings 33 and 34 and the rotary shaft 8 and C_{rf}=electrostatic capacitance between the rotor 6 and the outer frame.

According to the embodiment of the invention, the connecting part 3A small in sectional area is used for coupling the inner peripheral sides of the adjoining tooth portion cores 3, and the rotor 6 is disposed opposite to the inner peripheral sides of the tooth portion cores 3 with the gap held therebetween, so that the stator coils 5 and the rotor 6 are shielded as an electrical connection between the tooth portion cores 3 of the stator is established. The axial voltage V2 of the motor can greatly be decreased because the value of the electrostatic capacitance Cₛᵣ between the stator coils 5 and the rotor 6 is infinitely reducible up to zero.

Therefore, the stator 1 is formed with the ring-like yoke core 2, the tooth portion cores 3 arranged at equal intervals on the inner peripheral side of the yoke core 2, the stator coils 5 attached by inserting to each slot part 4 formed between the adjoining tooth portion cores 3, and the connecting part 3A having a small sectional area for coupling the inner peripheral sides of the adjoining tooth portion cores 3 so as to electrostatically shield the portion between the stator 1 and the rotor 6, the rotor 6 being set opposite to the inner peripheral sides of the tooth portion cores 3 with the gap held therebetween, according to the embodiment of the invention, whereby it is possible to lower the axial voltage and to prevent the development of the electrolytic corrosion by cutting off the electrostatic capacitance from the slot parts 4 to the rotor 6.

As the current generated by the magnetic field of the stator 1 is not allowed to flow, an increase in loss and a drop in motor efficiency will never take place.

Moreover, those measures heretofore taken to stick a metal plate as a magnetic material to the internal circumference on the stator coil side and to especially widen the gap between the stator and the rotor can be dispensed with. Thus, the rotary electric machine such as an AC motor suitable as an inverter-driven synchronous motor or an induction motor, having an inexpensive electrostatic shield structure and requiring not so many manufacturing man-hours, is obtainable because the motor can be shielded without lowering motor efficiency only by forming the connecting part 3A.

Although a description has been given of the connecting part provided in the stator as what constitutes the feature of the synchronous motor using the surface magnet type rotor according to the embodiment of the invention, the invention can be applied to a rotary electric machine such as a synchronous motor using an internal magnetic type rotor or any other induction motor. Although the rotary electric machine according to the embodiment of the invention has been described by way of example, the invention is applicable to direct-acting machines (e.g., a linear motor supported by using rolling bearings).

### Industrial Applicability

The rotary electric machine is useful as a rotary electric machine such as an AC motor suitable as an inverter-driven synchronous motor or an induction motor, for example.

1. A rotary electric machine comprising;
a fixed portion having a frame, a bracket mounted to one opening of the frame and a bracket mounted to the other opening thereof;
a stator mounted to the inner peripheral side of the frame with coils wound on slots;
a rotary shaft rotatably supported by the brackets via bearings; and
a rotor mounted to the rotary shaft,
wherein the stator includes a ring-like yoke core, tooth portion cores arranged at equal intervals on the inner peripheral side of the yoke core, stator coils attached by inserting to each slot formed between the adjoining tooth portion cores and a connecting part for coupling the inner peripheral sides of the adjoining tooth portion cores so as to electro-statically shield the portion between the stator and the rotor and
wherein the rotor opposes to the inner peripheral sides of the tooth portion cores with a gap held therebetween.
